(19) United States
(12) Patent Application Publication
(10) Pub. No.: US 2026/0264538 A1
(43) Pub. Date: Sep. 10, 2026

(54) SYSTEMS AND METHODS FOR MANAGING TORQUE DURING CHARGING OF A VEHICLE BATTERY

(71) Applicant: GM GLOBAL TECHNOLOGY OPERATIONS LLC, Detroit, MI (US)

(72) Inventors: Chandra S. Namuduri, Troy, MI (US); Renato Amorim Torres, Pontiac, MI (US); Peng Peng, Rochester Hills, MI (US); Lei Hao, Shelby Township, MI (US); Mohamed Kamel, Birmingham, MI (US); Yilun Luo, Ann Arbor, MI (US)

(73) Assignee: GM GLOBAL TECHNOLOGY OPERATIONS LLC, Detroit, MI (US)

(21) Appl. No.: 19/075,518

(22) Filed: Mar. 10, 2025

(51) Int. Cl. B60L 50/60; B60L 50/51

(52) U.S. Cl. CPC B60L 50/60; B60L 50/51; B60L 2210/10; B60L 2240/423

(57) ABSTRACT

An angular position of a rotor is received from a rotor position sensor. An offset angle is determined based on the angular rotor position with respect to a first phase terminal of an electric motor. A source alternating current (AC) value of a single phase AC received from a single phase AC power source is received. A desired first phase current value, a desired second phase current value, and a desired third phase current value are determined based on the source AC value and the offset angle. Commands are issued to an inverter system to apply different first terminal voltage values to the first phase terminal, different second terminal voltage values to a second phase terminal, and different third terminal voltage values to a third phase terminal until first, second, and third phase current values are equal to the desired first, second, and third phase current values.

### INTRODUCTION

The technical field generally relates to vehicles, and more particularly relates to systems and methods for managing torque during charging of a vehicle battery.

Electric vehicles (EV) and/or hybrid vehicles typically include an inverter system and a three phase electric motor. The inverter system is electrically coupled to the three phase electric motor and to the vehicle battery. A controller typically controls routing of current from the vehicle battery to the three terminal electric motor via the inverter system to propel the vehicle.

In many instances, the inverter system may be configured to be electrically coupled to a single phase alternating current (AC) source to charge the vehicle battery. Torque may be generated during the charging process based on a position of a rotor of the three phase electric motor.

Accordingly, it is desirable to provide systems and methods for managing torque during charging of a vehicle battery. Other desirable features and characteristics will become apparent from the subsequent detailed description and the appended claims, taken in conjunction with the accompanying drawings and the foregoing technical field and background.

### SUMMARY

A method of managing torque during charging of a vehicle battery includes: receiving, by the controller, an angular position of a rotor of an electric motor of a vehicle from a rotor position sensor; determining, by the controller, an offset angle based on the angular rotor position of the rotor with respect to a first phase terminal of the electric motor; receiving, by a controller, a source alternating current (AC) value of a single phase AC received from a single phase AC power source from a source current sensor of a vehicle; determining, by the controller, a desired first phase current value, a desired second phase current value, and a desired third phase current value based on the source AC value and the offset angle; and iteratively issuing a plurality of commands, by the controller, to an inverter system of the vehicle to apply different first terminal voltage values of a first terminal voltage to the first phase terminal of the electric motor, different second terminal voltage values of a second terminal voltage to a second phase terminal of the electric motor, and different third terminal voltage values of a third terminal voltage to a third phase terminal of the electric motor until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value, wherein: the controller is electrically coupled to the source current sensor, the rotor position sensor, the first phase current sensor, the second phase current sensor, the third phase current sensor, and the inverter system, the inverter system is electrically coupled to the first, second and third phase terminals of the electric motor, and the inverter system is configured to provide electrical coupling between the AC single phase power source and the vehicle battery to enable charging of the vehicle battery.

In at least one embodiment, the method further includes: determining, by the controller, the desired first phase current value using a first equation, the first equation being:

$${i}_{PC 1} = {i}_{AC}$$

wherein, i_{PC1} is the desired first phase current value, i_{AC} is a desired source AC value, and θ₀ is the offset angle; determining, by the controller, the desired second phase current value using a second equation, the second equation being:

$${i}_{PC 2} = - {i}_{AC} [ \frac{cos ( {θ}_{0} + \frac{π}{3} )}{cos {θ}_{0}} ]$$

wherein, i_{PC2} is the desired second phase current value, i_{AC} is a desired source AC value, and θ₀ is the offset angle; and determining, by the controller, the third desired phase current value using a third equation, the third equation being:

$${i}_{PC 3} = - {i}_{AC} [ \frac{sin ( {θ}_{0} + \frac{π}{6} )}{cos {θ}_{0}} ] .$$

wherein, i_{PC3} is the desired third phase current value, i_{AC} is the desired source AC value, and θ₀ is the offset angle.

In at least one embodiment, a desired source AC value is equal to the source AC value.

In at least one embodiment, the method further includes: defining, by the controller, a direct-quadrature (D-Q) coordinate system including a direct (D) axis aligned with the offset angle and a quadrature (Q) axis at a 90° angle with respect to the D axis; generating, by the controller, a D axis current value of a desired AC value using a Park transformation, the D axis current value being a projection of the desired AC value onto the D axis; issuing, by the controller, a command to the inverter system to apply a D axis based voltage to the first phase terminal of the electric motor to generate the D axis current value as the first phase current value at the first phase terminal; generating, by the controller, a first Q axis current value of the desired AC value using the Park transformation, the first Q axis current value being a projection of the desired AC value onto the Q axis; and determining, by the controller, the desired second phase current value and the desired third phase current value based on a sum of the first Q axis current value, a second Q axis current value, and a third Q axis current value being equal to zero, wherein: the second Q axis current value is based on a projection of the desired second phase current value onto the Q axis and is derived using the Park transformation, and the third Q axis current value is based on a projection of the desired third phase current value onto the Q axis and is derived using the Park transformation.

In at least one embodiment, the method further includes: determining, by the controller, whether the first phase terminal is an A phase terminal of the electric motor; and calculating, by the controller, the D axis current value of a desired AC value using a fourth equation based on the determination, the fourth equation being:

$${i}_{d} = \frac{{i}_{AC}}{cos ( {θ}_{0} )}$$

wherein, i_{d} is the D axis current value, i_{AC} is the desired AC value, and θ₀ is the offset angle.

In at least one embodiment, the method further includes: determining, by the controller, whether the first phase terminal is a B phase terminal of the electric motor; and calculating, by the controller, the D axis current value of the source AC value using a fifth equation based on the determination, the fifth equation being:

$${i}_{d} = \frac{{i}_{AC}}{cos ( {θ}_{0} - 2 π / 3 )}$$

wherein, i_{d} is the D axis current value, i_{AC} is the desired AC value, and θ₀ is the offset angle.

In at least one embodiment, the method further includes: determining, by the controller, whether the first phase terminal is a C phase terminal of the electric motor; and calculating, by the controller, the D axis current value of the desired AC value using a sixth equation based on the determination, the sixth equation being:

$${i}_{d} = \frac{{i}_{AC}}{cos ( {θ}_{0} - 4 π / 3 )}$$

wherein, i_{d} is the D axis current value, i_{AC} is the desired AC current value, and θ₀ is the offset angle.

In at least one embodiment, the first Q axis current value is represented by a seventh equation the seventh equation being:

$${i}_{q 1} = {i}_{AC} sin {θ}_{0}$$

wherein, i_{q1} is the first Q axis current value, i_{AC} is the desired AC value, and θ₀ is the offset angle; the second Q axis current value is represented by a eighth equation, the eighth equation being:

$${i}_{q 2} = {i}_{P C 2} sin ( {θ}_{0} - \frac{2 π}{3} )$$

wherein, i_{q2} is the second Q axis current value, i_{PC2} is the desired second phase current value, and θ₀ is the offset angle; the third Q axis current value is represented by an ninth equation, the ninth equation being:

$${i}_{q 3} = {i}_{P C 3} sin ( {θ}_{0} + \frac{2 π}{3} )$$

wherein, i_{q3} is the third Q axis current value, i_{PC3} is the desired third phase current value, and θ₀ is the offset angle, and

$${i}_{q 1} + {i}_{q 2} + {i}_{q 3} = 0$$

wherein, i_{q1} is the first Q axis current value, i_{q2} the second Q axis current value, and i_{q3} the third Q axis current value.

In at least one embodiment, the electric motor includes an A phase terminal, a B phase terminal, and a C phase terminal, the A phase terminal is associated with an A positive polarity position and an A negative polarity position on a stator of the electric motor, the B phase terminal is associated with a B positive polarity position and a B negative polarity position on the stator, a C phase terminal is associated with a C positive polarity position and a C negative polarity position on the stator, and the method further includes: upon a determination, by the controller, that one of the A positive polarity position and the A negative polarity position is closest to the angular position of the rotor, selecting the A phase terminal as the first phase terminal; upon a determination, by the controller, that one of the B positive polarity position and the B negative polarity position is closest to the angular position of the rotor, selecting the B phase terminal as the first phase terminal; and upon a determination, by the controller, that one of the C positive polarity position and the C negative polarity position is closest to the angular position of the rotor, selecting the C phase terminal as the first phase terminal.

In at least one embodiment, the method further includes: issuing a routing command, by the controller, to the inverter system to supply a charging voltage from the inverter system to the vehicle battery via a direct current to a direct current (DC-DC) converter, the charging voltage being associated with the single phase AC received from the single phase AC power source.

In at least one embodiment, the electric motor includes an A phase terminal, a B phase terminal, and a C phase terminal, and two of the A phase terminal, the B phase terminal, and the C phase terminal are available for selection, by the controller, as the first phase terminal.

In at least one embodiment, the method further includes: determining, by the controller, whether the offset angle is zero; and upon a determination that the offset angle is zero: determining, by the controller, the desired second phase current value to be half of the source AC value and have a phase with a polarity that is opposite a polarity of the single phase AC; and determining, by the controller, the desired third phase current value to be half of the source AC value and have a phase with a polarity that is opposite the polarity of the single phase AC.

A system for managing torque during charging of a vehicle battery includes at least one processor and at least one memory communicatively coupled to the at least one processor. The at least one memory includes instructions that upon execution by the at least one processor, causes the at least one processor to: receive an angular position of a rotor of an electric motor of a vehicle from a rotor position sensor; determine an offset angle based on the angular rotor position of the rotor with respect to a first phase terminal of the electric motor; receive a source alternating current (AC) value of a single phase AC received from a single phase AC power source from a source current sensor of a vehicle; determine a desired first phase current value, a desired second phase current value, and a desired third phase current value based on the source AC value and the offset angle; and iteratively issue a plurality of commands to an inverter system of the vehicle to apply different first terminal voltage values of a first terminal voltage to the first phase terminal of the electric motor, different second terminal voltage values of a second terminal voltage to a second phase terminal of the electric motor, and different third terminal voltage values of a third terminal voltage to a third phase terminal of the electric motor until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value, wherein: the at least one processor is electrically coupled to the source current sensor, the rotor position sensor, the first phase current sensor, the second phase current sensor, the third phase current sensor, and the inverter system, the inverter system is electrically coupled to the first, second and third phase terminals of the electric motor, and the inverter system is configured to provide electrical coupling between the AC single phase power source and the vehicle battery to enable charging of the vehicle battery.

In at least one embodiment, the at least one memory further includes instructions that upon execution by the at least one processor, causes the at least one processor to determine the desired first phase current value using a first equation, the first equation being:

$${i}_{P C 1} = {i}_{A C}$$

wherein, i_{PC1} is the desired first phase current value, i_{AC} is a desired source AC value, and θ₀ is the offset angle; determine the desired second phase current value using a second equation, the second equation being:

$${i}_{PC 2} = - {i}_{AC} [ \frac{cos ( {θ}_{0} + \frac{π}{3} )}{{cosθ}_{0}} ]$$

wherein, i_{PC2} is the desired second phase current value, i_{AC} is a desired source AC value, and θ₀ is the offset angle; and determine the third desired phase current value using a third equation, the third equation being:

$${i}_{PC 3} = - {i}_{AC} [ \frac{sin ( {θ}_{0} + \frac{π}{3} )}{{cosθ}_{0}} ] .$$

wherein, i_{PC3} is the desired third phase current value, i_{AC} is the desired source AC value, and θ₀ is the offset angle.

In at least one embodiment, the at least one memory further includes instructions that upon execution by the at least one processor, causes the at least one processor to: define a direct-quadrature (D-Q) coordinate system including a direct (D) axis aligned with the offset angle and a quadrature (Q) axis at a 90° angle with respect to the D axis; generate a D axis current value of a desired AC value using a Park transformation, the D axis current value being a projection of the desired AC value onto the D axis; issue a command to the inverter system to apply a D axis based voltage to the first phase terminal of the electric motor to generate the D axis current value as the first phase current value at the first phase terminal; generate a first Q axis current value of the desired AC value using the Park transformation, the first Q axis current value being a projection of the desired AC value onto the Q axis; and determine the desired second phase current value and the desired third phase current value based on a sum of the first Q axis current value, a second Q axis current value, and a third Q axis current value being equal to zero, wherein: the second Q axis current value is based on a projection of the desired second phase current value onto the Q axis and is derived using the Park transformation, and the third Q axis current value is based on a projection of the desired third phase current value onto the Q axis and is derived using the Park transformation.

In at least one embodiment, the at least one memory further includes instructions that upon execution by the at least one processor, causes the at least one processor to: determine whether the first phase terminal is an A phase terminal of the electric motor; and calculate the D axis current value of a desired AC value using a fourth equation based on the determination, the fourth equation being:

$${i}_{d} = \frac{{i}_{AC}}{cos ( {θ}_{0} )}$$

wherein, i_{d} is the D axis current value, i_{AC} is the desired AC value, and θ₀ is the offset angle.

In at least one embodiment, the at least one memory further includes instructions that upon execution by the at least one processor, causes the at least one processor to: determine whether the first phase terminal is a B phase terminal of the electric motor; and calculate the D axis current value of the source AC value using a fifth equation based on the determination, the fifth equation being:

$${i}_{d} = \frac{{i}_{AC}}{cos ( {θ}_{0} - 2 π / 3 )}$$

wherein, i_{d} is the D axis current value, i_{AC} is the desired AC value, and θ₀ is the offset angle.

In at least one embodiment, the method further includes: the at least one memory further includes instructions that upon execution by the at least one processor, causes the at least one processor to: determine whether the first phase terminal is a C phase terminal of the electric motor; and calculate the D axis current value of the desired AC value using a sixth equation based on the determination, the sixth equation being:

$${i}_{d} = \frac{{i}_{A C}}{c o s ( {θ}_{0} - 4 π / 3 )}$$

wherein, i_{d} is the D axis current value, i_{AC} is the desired AC current value, and θ₀ is the offset angle.

In at least one embodiment, the method further includes: the first Q axis current value is represented by a seventh equation the seventh equation being:

$${i}_{q 1} = {i}_{A C} sin {θ}_{0}$$

wherein, i_{q1} is the first Q axis current value, i_{AC} is the desired AC value, and θ₀ is the offset angle; the second Q axis current value is represented by a eighth equation, the eighth equation being:

$${i}_{q 2} = {i}_{PC 2} sin ( {θ}_{0} - \frac{2 π}{3} )$$

wherein, i_{q2} is the second Q axis current value, i_{PC2} is the desired second phase current value, and θ₀ is the offset angle; the third Q axis current value is represented by an ninth equation, the ninth equation being:

$${i}_{q 3} = {i}_{PC 3} sin ( {θ}_{0} + \frac{2 π}{3} )$$

wherein, i_{q3} is the third Q axis current value, i_{PC3} is the desired third phase current value, and θ₀ is the offset angle, and

$${i}_{q 1} + {i}_{q 2} + {i}_{q 3} = 0$$

wherein, i_{q1} is the first Q axis current value, i_{q2} the second Q axis current value, and i_{q3} the third Q axis current value.

A vehicle including a system for managing torque during charging of a vehicle battery including at least one processor and at least one memory communicatively coupled to the at least one processor. The at least one memory includes instructions that upon execution by the at least one processor, causes the at least one processor to: receive an angular position of a rotor of an electric motor of a vehicle from a rotor position sensor; determine an offset angle based on the angular rotor position of the rotor with respect to a first phase terminal of the electric motor; receive a source alternating current (AC) value of a single phase AC received from a single phase AC power source from a source current sensor of a vehicle; determine a desired first phase current value, a desired second phase current value, and a desired third phase current value based on the source AC value and the offset angle; and iteratively issue a plurality of commands to an inverter system of the vehicle to apply different first terminal voltage values of a first terminal voltage to the first phase terminal of the electric motor, different second terminal voltage values of a second terminal voltage to a second phase terminal of the electric motor, and different third terminal voltage values of a third terminal voltage to a third phase terminal of the electric motor until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value, wherein: the at least one processor is electrically coupled to the source current sensor, the rotor position sensor, the first phase current sensor, the second phase current sensor, the third phase current sensor, and the inverter system, the inverter system is electrically coupled to the first, second and third phase terminals of the electric motor, and the inverter system is configured to provide electrical coupling between the AC single phase power source and the vehicle battery to enable charging of the vehicle battery.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a torque management system in accordance with at least one embodiment;

FIG. 2 is functional block diagram of a vehicle configured to implement a torque management system in accordance with at least one embodiment;

FIG. 3 is a flowchart representation of a method of managing torque during charging of a vehicle battery using a three phase A, B, C framework in accordance with at least one embodiment;

FIG. 4 is an exemplary representation of possible angular rotor positions of a rotor with respect to a stator of an electric motor in accordance with at least one embodiment;

FIG. 5 is a flowchart representation of a method of managing torque during charging of a vehicle battery using a direct-quadrature framework in accordance with at least one embodiment;

FIG. 6 is a graphical illustration of an exemplary direct-quadrature (D-Q) coordinate system based on an offset angle θ₀ with respect to a three phase current A, B, C coordinate system in accordance with at least one embodiment;

FIG. 7 is a graphical illustration of an exemplary D-Q coordinate system where an angular position of a rotor is aligned with an A phase terminal of an electric motor in accordance with at least one embodiment; and

FIG. 8 is an exemplary circuit diagram of an inverter system electrically coupled to an electric motor, a single phase AC power source, and leg circuitry via a direct current (DC) bus in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

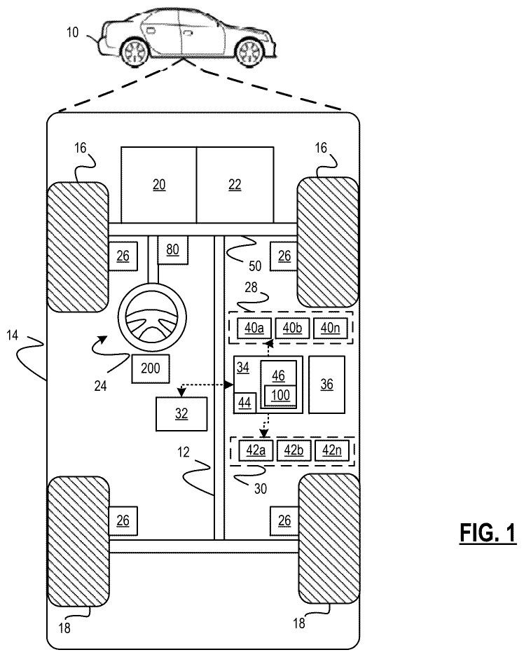

Referring to FIG. 1, a functional block diagram of a vehicle 10 including a torque management system 100 in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 may, in various embodiments, include an electric machine such as a traction motor, a fuel cell propulsion system, and/or any other type of propulsion configuration. In at least one embodiment, the propulsion system 20 includes an electric machine and an internal combustion engine (ICE). In at least one embodiment, the propulsion system 20 includes an electric machine. In at least one embodiment, the electric machine is a three terminal electric motor. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In at least one embodiment, the vehicle 10, includes a controller 34 that is configured as an inverter controller and the computer-readable storage device 46 is at least one memory configured to store the torque management system 100.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

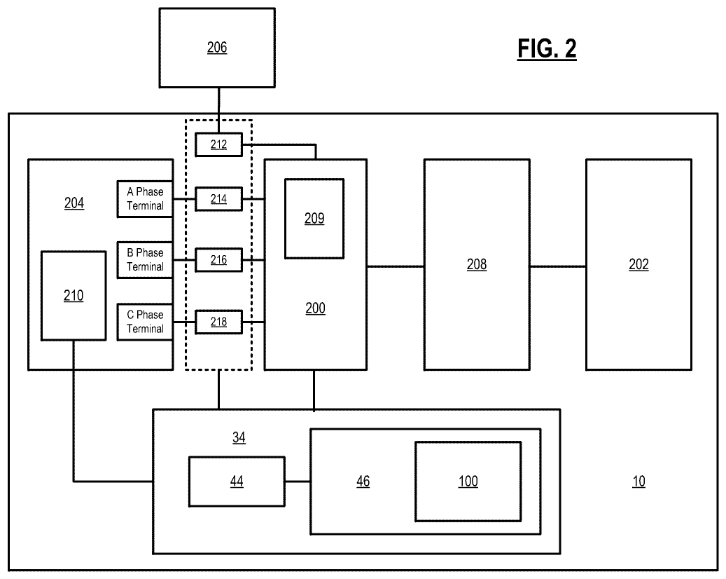

Referring to FIG. 2, a functional block diagram of a vehicle 10 configured to implement a torque management system 100 in accordance with at least one embodiment is shown. A controller 34 includes at least one processor 44 and at least one memory 46. The at least one processor 44 is a programable device that includes one or more instructions stored in or associated with the at least one memory 46. The at least one memory 46 includes instructions that the at least one processor 44 is configured to execute. The at least one memory 46 includes an embodiment of the torque management system 100.

The vehicle 10 includes an inverter system 200. During operation of the vehicle 10, the inverter system 200 is configured to route current from a vehicle battery 202 to an electric motor 204 to propel the vehicle 10. The inventor system 200 is electrically coupled to the vehicle battery 202 and configured to be electrically coupled to a single phase alternative current (AC) power source 206 to enable charging of the vehicle battery 202.

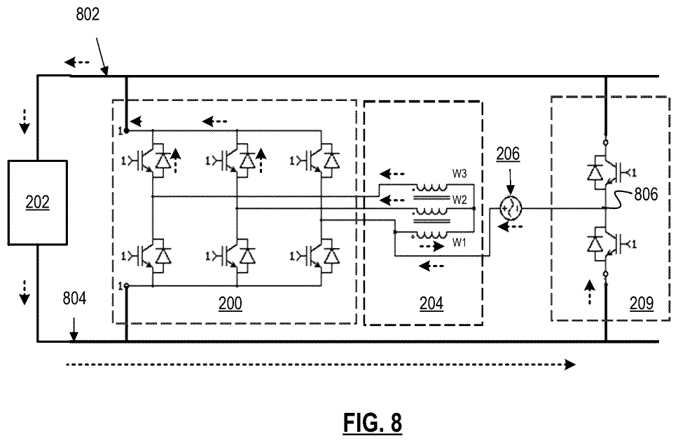

The inverter system 200 is electrically coupled to the vehicle battery 202 via a direct current to direct current (DC-DC) converter 208. The DC-DC converter 208 is configured to adjust a charging voltage associated with the charging of the vehicle battery 202 so that the adjusted charging voltage used to charge the vehicle battery 202 is compatible with the vehicle battery 202. In at least one embodiment, the DC-DC converter 208 is a dual active bridge. In alternative embodiments, the inverter system 200 is directly electrically coupled to the vehicle battery 202 without the use of a DC-DC converter 208. In at least one embodiment, the inverter system 200 includes leg circuitry 209. In at least one embodiment, the leg circuitry 209 is separate from the inverter system 200. The operation of the leg circuitry 209 will be described in greater detail below with reference to FIG. 8.

The electric motor 204 is a three phase electric motor that include an A phase terminal, a B phase terminal, and a C phase terminal. During the charging process, the torque management system 100 is configured to designate a first one of the A phase terminal, the B phase terminal, and the C phase terminal as a first phase terminal, a second one of the A phase terminal, the B phase terminal, and the C phase terminal as a second phase terminal and a third one of the A phase terminal, the B phase terminal, and the C phase terminal as a third phase terminal. The inverter system 200 is electrically coupled to the A phase terminal, the B phase terminal, and the C phase terminal.

The electric motor 204 includes a stator (not shown), a rotor (not shown), and a rotor position sensor 210. The rotor position sensor 210 is configured to detect an angular rotor position of the rotor. In at least one embodiment, the rotor position sensor 210 is a resolver. The resolver outputs electrical signals that correspond to the angular rotor position of the rotor.

The vehicle 10 includes a source current sensor 212, an A phase current sensor 214, a B phase current sensor 216, and a C phase current sensor 218. The source current sensor 212 is configured to generate a source AC value of a single phase AC received at the vehicle 10 from the single phase AC power source 206. The A phase current sensor 214 is configured to generate an A phase current value. The B phase current sensor 216 is configured to generate a B phase current value. The C phase current sensor 216 is configured to generate a C phase current value.

The controller 34 is electrically coupled to the source current sensor 212, the rotor position sensor 210, the A phase current sensor 214, the B phase current sensor 216, the C phase current sensor 218, and the inverter system 200. The processor 44 is electrically coupled to the source current sensor 212, the rotor position sensor 210, the A phase current sensor 214, the B phase current sensor 216, the C phase current sensor 218, and the inverter system 200.

The vehicle 10 may include additional components that facilitate operation of the torque management system 100. The controller 34 may include additional components that facilitate operation of the torque management system 100. The torque management system 100 is configured to manage torque that may be generated during the vehicle battery 202 charging process. Operation of the torque management system 100 will be described in greater detail below.

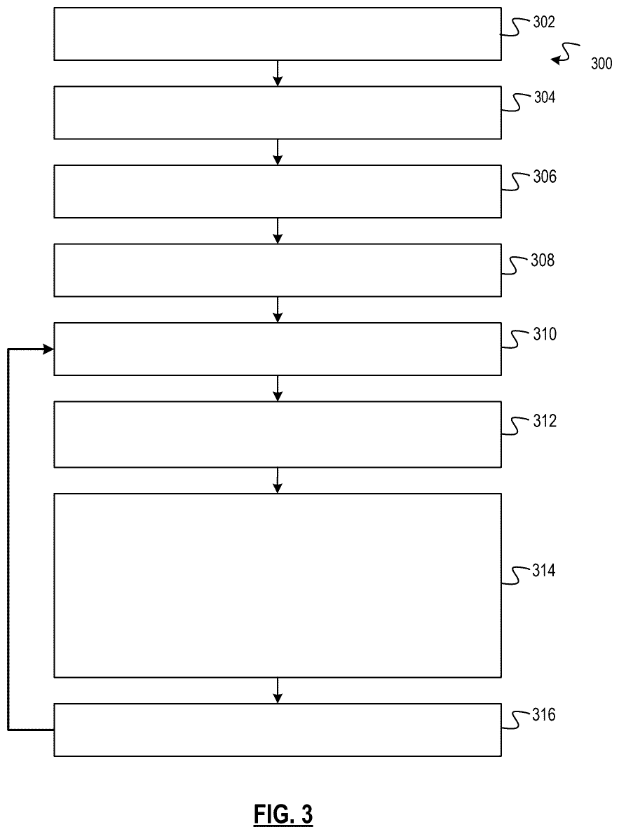

Referring to FIG. 3, a flowchart representation of a method 300 of managing torque during charging of a vehicle battery 202 using a three phase A, B, C framework in accordance with at least one embodiment is shown. The method 300 will be described with reference to an exemplary implementation of an embodiment of a torque management system 100. The torque management system 100 is configured to manage torque that may be generated during charging of a vehicle battery 202. As can be appreciated in light of the disclosure, the order of operation within the method 300 is not limited to the sequential execution as illustrated in FIG. 3 but may be performed in one or more varying orders as applicable and in accordance with the present disclosure.

At 302, the torque management system 100 detects that a single phase AC power source 206 has been electrically coupled to an inverter system 200 of the vehicle 10 to charge the vehicle battery 202. In at least one embodiment, the vehicle 10 includes a charging connector. The charging connector is electrically coupled to the inverter system 200. The inverter system 200 is configured to detect that the charging connector has been electrically coupled to the single phase AC power source 206 and responsively generates a vehicle charging notification. The torque management system 100 is configured to receive the vehicle charging notification from the inverter system 200. The torque management system 100 detects that the single phase AC power source 206 has been electrically coupled to the inverter system 200 upon receipt of the vehicle charging notification.

At 304, the torque management system 100 receives an angular rotor position of a rotor of the electric motor 204 from a rotor position sensor 210. The electric motor 204 is a three phase electric motor and includes an A phase terminal, a B phase Terminal and a C phase terminal. The electric motor 204 includes the rotor and a stator. In at least one embodiment, the electric motor 204 is an interior permanent magnet (IPM) motor. In alternative embodiments, the electric motor 204 may be a different type of electric motor. In at least one embodiment, the rotor position sensor 210 is a resolver.

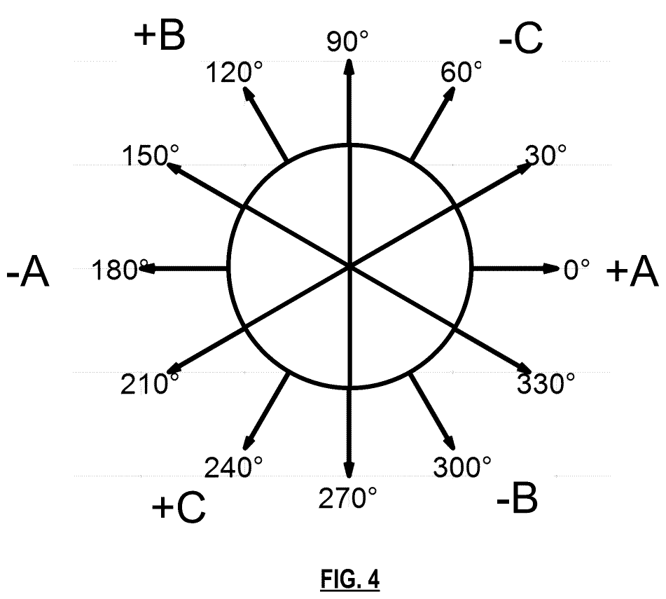

At 306, the torque management system 100 selects one of the A phase terminal, the B phase terminal, and the C phase terminal of the electric motor 204 as a first phase terminal. Referring to FIG. 4, an exemplary representation of possible angular rotor positions of a rotor with respect to a stator of an electric motor 204 in accordance with at least one embodiment is shown. The electric motor 204 includes an A phase terminal, a B phase terminal, and a C phase terminal. The A phase terminal is associated with a positive polarity position +A at 0°, and a negative polarity position −A at 180° on the stator. The B phase terminal is associated with a positive polarity position +B at 120°, and a negative polarity position −B at 300° on the stator. The C phase terminal is associated with a positive polarity position +C at 240°, and a negative polarity position −C at 60° on the stator.

If the angular rotor position of the rotor falls between 30° and 330° positions of the stator or between 150° and 210° positions of the stator, the torque management system 100 selects the A phase terminal as the first phase terminal. The A phase terminal is determined to be closest to the angular rotor position. The B phase terminal is defined as the second phase terminal and the C phase terminal is defined as the third phase terminal.

If the angular rotor position of the rotor falls between 90° and 150° positions of the stator or between 270° and 330° positions of the stator, the torque management system 100 selects the B phase terminal as the first phase terminal. The B phase terminal is determined to be closest to the angular rotor position. The C phase terminal is defined as the second phase terminal and the A phase terminal is defined as the third phase terminal.

If the angular rotor position of the rotor falls between 30° and 90° positions of the stator or between 210° and 270° positions of the stator, the torque management system 100 selects the C phase terminal as the first phase terminal. The C phase terminal is determined to be closest to the angular rotor position. The A phase terminal is defined as the second phase terminal and the C phase terminal is defined as the third phase terminal.

In an alternative embodiment, two of the A phase terminal, the B phase terminal, and the C phase terminal are available for selection as the first phase terminal by the torque management system 100. In at least one embodiment, only the A phase terminal and the B phase terminal are available for selection as the first phase terminal by the torque management system 100. The first phase terminal is selected based on the one of the A phase terminal and the B phase terminal that is closest to the angular rotor position.

In at least one embodiment, only the B phase terminal and the C phase terminal are available for selection as the first phase terminal by the torque management system 100. The first phase terminal is selected based on the one of the B phase terminal and the C phase terminal that is closest to the angular rotor position.

In at least one embodiment, only the A phase terminal and the C phase terminal are available for selection as the first phase terminal by the torque management system 100. The first phase terminal is selected based on the one of the A phase terminal and the C phase terminal that is closest to the angular rotor position. Fewer relays are used when the torque management system 100 is limited to selecting one of two phase terminals compared to when the torque management system 100 has the option of selecting one of the three phase terminals.

Referring back to FIG. 3, at 308 the torque management system 100 determines an offset angle θ₀ between the angular rotor position and the first phase terminal.

At 310, the torque management system 100 receives a source AC value of a single phase AC received from the single phase AC power source 206 from a source current sensor 212 of the vehicle 10. The single phase AC is an alternating current. The source AC value of the single phase AC varies over time. The source current sensor 212 is configured to detect the source AC value of the single phase AC in real time. The torque management system 100 is configured to receive the source AC values of the single phase AC as they are detected by the source current sensor 212 in real time.

At 312, the torque management system 100 determines a desired first phase current value i_{PC1} of the first phase current associated with the first phase terminal of the electric motor 204, a desired second phase current value i_{PC2} of a second phase current associated with the second phase terminal of the electric motor 204 and a desired third phase current value i_{PC3} of a third phase current associated with the third phase terminal of the electric motor 204.

The torque management system 100 determines the desired first phase current value i_{PC1} of the first phase current using the equation below:

$${i}_{PC 1} = {i}_{A C}$$

where: i_{PC1} is the desired second phase current value and i_{AC} is the desired source AC value. In at least one embodiment, the source AC value of the single phase AC received from the single phase AC power source 206 is the desired source AC value.

The torque management system 100 determines the desired second phase current value i_{PC2} of the second phase current using the equation below:

$${i}_{PC 2} = - {i}_{A C} [ \frac{cos ( {θ}_{0} + \frac{π}{3} )}{cos {θ}_{0}} ]$$

where: i_{PC2} is the desired second phase current value, i_{AC} is the desired source AC value, and θ₀ is the offset angle.

The torque management system 100 determines the desired third phase current value i_{PC3} of the third phase current using the equation below:

$${i}_{PC 3} = - {i}_{PC 1} [ \frac{sin ( {θ}_{0} + \frac{π}{6} )}{cos {θ}_{0}} ]$$

where: i_{PC3} is the desired third phase current value, i_{AC} is the desired source AC value, and θ₀ is the offset angle.

At 314, the torque management system 100 iteratively issues commands to the inverter system 200 to apply different first terminal voltages values of a leg circuitry terminal of a leg circuitry 209 to the first phase terminal of the electric motor 204, different second terminal voltage values of a second terminal voltage to the second phase terminal of the electric motor 204, and different third terminal voltage values of a third terminal voltage to a third phase terminal of the electric motor 204 until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value.

The first phase current sensor is one of an A phase current sensor 214, a B phase current sensor 216, and a C phase current sensor 218 in accordance with the first phase terminal defined by the torque management system 100. The second phase current sensor is one of the A phase current sensor 214, the B phase current sensor 216, and the C phase current sensor 218 in accordance with the second phase terminal defined by the torque management system 100. The third phase current sensor is one of the A phase current sensor 214, the B phase current sensor 216, and the C phase current sensor 218 in accordance with the third phase terminal defined by the torque management system 100.

At 316, the torque management system 100 issues a command to the inverter system 200 to supply a charging voltage to the vehicle battery 202 via the DC-DC converter 208. The charging voltage is associated with the single phase AC received from the single phase AC power source 206. The method 300 returns to 310. The torque management system 100 dynamically manages the phase current values of the phase currents applied to the phase terminals of the electric motor 204 in real time as the source AC value of the single phase AC received from the single phase AC power source 206 varies.

When the value of a first terminal voltage applied to the first phase terminal of the electric motor 204 results in the first phase current value being equal to the desired first phase current value, the value of a second terminal voltage applied to the second phase terminal of the electric motor 204 results in the second phase current value being equal to the desired second phase current value, and the value of a third terminal voltage applied to the third phase terminal of the electric motor 204 results in the third phase current value being equal to the desired third phase current, torque generated by the electric motor 204 during the changing of the vehicle battery 202 is close to zero or negligible.

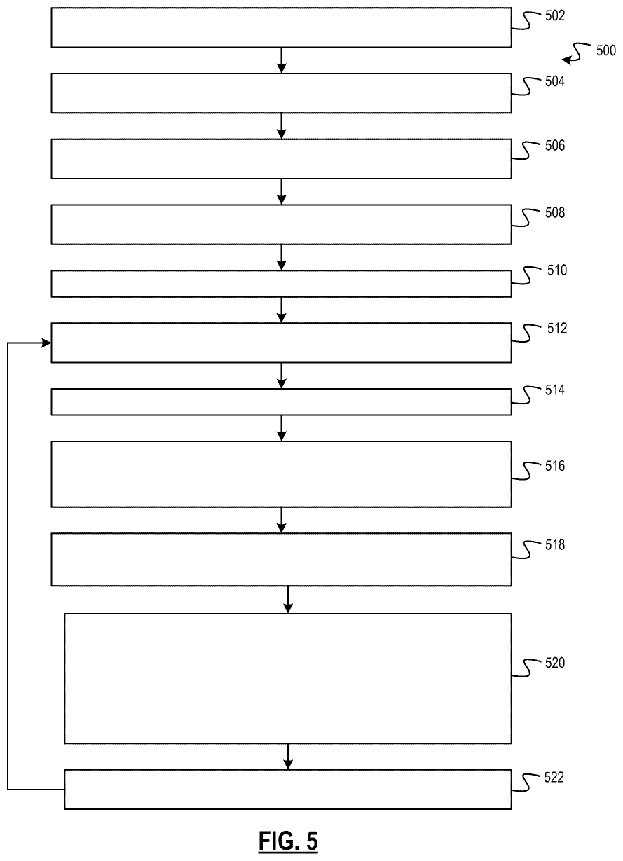

Referring to FIG. 5, a flowchart representation of a method 500 of managing torque during charging of a vehicle battery 202 using a direct-quadrature (D-Q) framework in accordance with at least one embodiment is shown. The method 500 will be described with reference to an exemplary implementation of an embodiment of a torque management system 100. The torque management system 100 is configured to manage torque that may be generated during charging of a vehicle battery 202. As can be appreciated in light of the disclosure, the order of operation within the method 500 is not limited to the sequential execution as illustrated in FIG. 5 but may be performed in one or more varying orders as applicable and in accordance with the present disclosure.

At 502, the torque management system 100 detects that a single phase AC power source 206 has been electrically coupled to an inverter system 200 of the vehicle 10 to charge the vehicle battery 202. In at least one embodiment, the vehicle 10 includes a charging connector. The charging connector is electrically coupled to the inverter system 200. The inverter system 200 is configured to detect that the charging connector has been electrically coupled to the single phase AC power source 206 and responsively generates a vehicle charging notification. The torque management system 100 is configured to receive the vehicle charging notification from the inverter system 200. The torque management system 100 detects that the single phase AC power source 206 has been electrically coupled to the inverter system 200 upon receipt of the vehicle charging notification.

At 504, the torque management system 100 receives an angular rotor position of a rotor of the electric motor 204 from a rotor position sensor 210. The electric motor 204 is a three phase electric motor and includes an A phase terminal, a B phase Terminal and a C phase terminal. The electric motor 204 includes the rotor and a stator. In at least one embodiment, the electric motor 204 is an interior permanent magnet (IPM) motor. In alternative embodiments, the electric motor 204 may be a different type of electric motor. In at least one embodiment, the rotor position sensor 210 is a resolver.

At 506, the torque management system 100 selects one of the A phase terminal, the B phase terminal, and the C phase terminal of the electric motor 204 as a first phase terminal. Referring to FIG. 4, an exemplary representation of possible angular rotor positions of a rotor with respect to a stator of an electric motor 204 in accordance with at least one embodiment is shown. The electric motor 204 includes an A phase terminal, a B phase terminal, and a C phase terminal. The A phase terminal is associated with a positive polarity position +A at 0°, and a negative polarity position −A at 180° on the stator. The B phase terminal is associated with a positive polarity position +B at 120°, and a negative polarity position −B at 300° on the stator. The C phase terminal is associated with a positive polarity position +C at 240°, and a negative polarity position −C at 60° on the stator.

If the angular rotor position of the rotor falls between 30° and 330° positions of the stator or between 150° and 210° positions on the stator, the torque management system 100 selects the A phase terminal as the first phase terminal. The A phase terminal is determined to be closest to the angular rotor position. The B phase terminal is defined as the second phase terminal and the C phase terminal is defined as the third phase terminal.

If the angular rotor position of the rotor falls between 90° and 150° positions of the stator or between 270° and 330° positions on the stator, the torque management system 100 selects the B phase terminal as the first phase terminal. The B phase terminal is determined to be closest to the angular rotor position. The C phase terminal is defined as the second phase terminal and the A phase terminal is defined as the third phase terminal.

If the angular rotor position of the rotor falls between 30° and 90° positions of the stator or between 210° and 270° positions on the stator, the torque management system 100 selects the C phase terminal as the first phase terminal. The C phase terminal is determined to be closest to the angular rotor position. The A phase terminal is defined as the second phase terminal and the C phase terminal is defined as the third phase terminal.

In an alternative embodiment, two of the A phase terminal, the B phase terminal, and the C phase terminal are available for selection as the first phase terminal by the torque management system 100. In at least one embodiment, only the A phase terminal and the B phase terminal are available for selection as the first phase terminal by the torque management system 100. The first phase terminal is selected based on the one of the A phase terminal and the B phase terminal that is closest to the angular rotor position.

In at least one embodiment, only the B phase terminal and the C phase terminal are available for selection as the first phase terminal by the torque management system 100. The first phase terminal is selected based on the one of the B phase terminal and the C phase terminal that is closest to the angular rotor position.

In at least one embodiment, only the A phase terminal and the C phase terminal are available for selection as the first phase terminal by the torque management system 100. The first phase terminal is selected based on the one of the A phase terminal and the C phase terminal that is closest to the angular rotor position. Fewer relays are used when the torque management system 100 is limited to selecting one of two phase terminals compared to when the torque management system 100 has the option of selecting one of the three phase terminals.

Referring back to FIG. 5, at 508, the torque management system 100 determines an offset angle θ₀ between the angular rotor position and the first phase terminal. At 510, the torque management system 100 defines a direct-quadrature (D-Q) coordinate system based on the offset angle θ₀. The direct (D) axis of the D-Q coordinate system is aligned with the offset angle θ₀. The quadrature (Q) axis is at a 90° angle with respect to the D axis.

At 512, the torque management system 100 receives a source AC value of a single phase AC received from the single phase AC power source 206 from a source current sensor 212 of the vehicle 10. The single phase AC is an alternating current. The source AC value of the single phase AC varies over time. The source current sensor 212 is configured to detect the source AC value of the single phase AC in real time. The torque management system 100 is configured to receive the source AC values of the single phase AC as they are detected by the source current sensor 212 in real time.

At 514, the torque management system 100 generates a D axis current value of the source AC value of the single phase AC received from the single phase AC power source 206. The torque management system 100 generates the D axis current value of the source AC value using a Park transformation. The D axis current value is a projection of the source AC value onto the D axis. In at least one embodiment, a power invariant Park transformation is used. In at least one embodiment, an amplitude invariant Park transformation is used. The D axis current value can be modified in accordance with a desired charging rate of the vehicle battery 202.

The torque management system 100 uses different equations to determine the D axis current value of the source AC current based on whether the A phase terminal, the B phase terminal, or the C phase terminal of the electric motor 204 has been selected as the first phase terminal.

When the torque management system 100 has determined that the A phase terminal of the electric motor 204 is the first phase terminal, the torque management system 100 uses the equation below to calculate the D axis current value of the source AC value.

$${i}_{d} = \frac{{i}_{A C}}{cos ( {θ}_{0} )}$$

where: i_{d} is the D axis current value, i_{AC} is the desired source AC value, and θ₀ is the offset angle. In at least one embodiment, the source AC value of the single phase AC received from the single phase AC power source 206 is the desired source AC value.

When the torque management system 100 has determined that the B phase terminal of the electric motor 204 is the first phase terminal, the torque management system 100 uses the equation below to calculate the D axis current value of the source AC value.

$${i}_{d} = \frac{{i}_{A C}}{cos ( {θ}_{0} - 2 π / 3 )}$$

where: i_{d} is the D axis current value, i_{AC} is the desired source AC value, and θ₀ is the offset angle.

When the torque management system 100 has determined that the C phase terminal of the electric motor 204 is the first phase terminal, the torque management system 100 uses the equation below to calculate the D axis current value of the source AC value.

$${i}_{d} = \frac{{i}_{A C}}{cos ( {θ}_{0} - 4 π / 3 )}$$

where: i_{d} is the D axis current value, i_{AC} is the desired source AC current value, and θ₀ is the offset angle.

At 516, the torque management system 100 generates a first Q axis current value, a second Q axis current value, and a third Q axis current value associated with a desired first phase current value, a desired second phase current value and a desired third phase current value, respectively. The desired first phase current value of the first phase current is associated with a first phase terminal of the electric motor 204, the desired second phase current value of a second phase current is associated with the second phase terminal of the electric motor 204 and the desired third phase current value of the third phase current is associated with the third phase terminal of the electric motor 204. The desired second phase current value and the desired third phase current value are based on a sum of the first Q axis current value, the second Q axis current value, and the third Q axis current value being equal to zero. The first Q axis current value is based on a projection of the desired first phase current value onto the Q axis derived using the Park transformation. The second Q axis current value is based on a projection of the desired second phase current value onto the Q axis derived using the Park transformation. The third Q axis current value is based on a projection of the desired third phase current value onto the Q axis derived using the Park transformation.

The first Q axis current value i_{q1} is represented by the equation below.

$${i}_{q 1} = {i}_{PC 1} sin {θ}_{0}$$

where: i_{q1} is the first Q axis current value, i_{PC1} is the desired first phase current value, and θ₀ is the offset angle.

The second Q axis current value i_{q2} is represented by the equation below.

$${i}_{q 2} = {i}_{PC 2} sin ( {θ}_{0} - \frac{2 π}{3} )$$

where: i_{q2} is the second Q axis current value, i_{PC2} is the desired second phase current value, and θ₀ is the offset angle.

The third Q axis current value i_{q3} is represented by the equation below

$${i}_{q 3} = {i}_{P C 3} sin ( {θ}_{0} + \frac{2 π}{3} )$$

where: i_{q3} is the third Q axis current value, i_{PC3} is the desired third phase current value, and θ₀ is the offset angle.

The sum of the first Q axis current value, the second Q axis current value, and the third Q axis current value is zero as represented by the equation below.

$${i}_{q 1} + {i}_{q 2} + {i}_{q 3} = 0$$

where: i_{q1} is the first Q axis current value, i_{q2} the second Q axis current value, and i_{q3} the third Q axis current value. When the sum of the first Q axis current value, i_{q1}, the second Q axis current value i_{q2} and the third Q axis current value i_{q3} is equal to zero, the torque that may be generated by the electric motor 204 during the charging of the vehicle battery 202 is zero or negligible.

At 518, the torque management system 100 issues a command to the inverter system 200 to apply a D axis based voltage to the first phase terminal to generate the D axis current value as the first phase current value at the first phase terminal. At 520, the torque management system 100 iteratively issue commands to the inverter system 200 to apply different second terminal voltage values of a second terminal voltage to the second phase terminal and to apply different third terminal voltage values of a third terminal voltage to the third phase terminal based on a Q axis based voltage until a detected second phase current value is equal to the desired second phase current value and a detected third phase current value is equal to the desired third phase current value.

At 522, the torque management system 100 issues a command to the inverter system 200 to supply a charging voltage to the vehicle battery 202 via the DC-DC converter 208. The charging voltage is associated with the single phase AC received from the single phase AC power source 206. The method 500 returns to 512. The torque management system 100 dynamically manages the phase current values of the phase currents applied to the phase terminals of the electric motor 204 in real time as the source AC value of the single phase AC received from the single phase AC power source 206 varies.

When the value of a second terminal voltage applied to the second phase terminal of the electric motor 204 results in the second phase current value being equal to the desired second phase current value and the value of a third terminal voltage applied to the third phase terminal of the electric motor 204 results in the third phase current value being equal to the desired third phase current value as the single phase AC having the source AC value is routed to the first phase terminal of the electric motor 204, torque generated by the electric motor 204 during the changing of the vehicle battery 202 is close to zero or negligible. When the method 500 is implemented, the D axis current value can be modified in accordance with a desired charging rate of the vehicle battery 202.

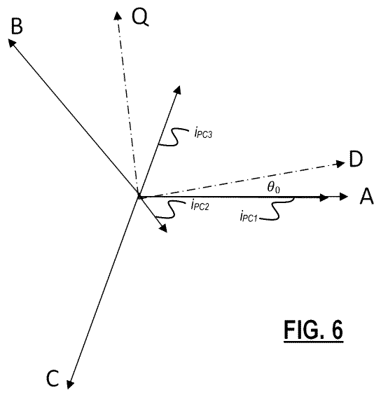

Referring to FIG. 6, a graphical illustration of an exemplary D-Q coordinate system based on an offset angle θ₀ with respect to a three phase current A, B, C coordinate system in accordance with at least one embodiment is shown. The three phase current ABC coordinate system includes an A axis, a B axis and a C axis. The first phase terminal is the A phase terminal, the second phase terminal is the B phase terminal, and the third phase terminal is the C phase terminal. The offset angle θ₀ is the angle between the angular rotor position of the rotor and the A phase terminal (the first phase terminal). The offset angle θ₀ is used to define the D axis of the D-Q coordinate system. The D axis is aligned with the offset angle θ₀. The Q axis is at a 90° angle with respect to the D axis. The first phase current value is the A phase current value i_{PC1} depicted along the A axis, the desired second phase current value is the B phase current value i_{PC2} depicted along the B axis, and the desired third phase current value is the C phase current value i_{PC3} depicted along the C axis.

A D axis current value is based on a projection of the first phase current value (A phase current value) onto the D axis and is derived using the Park transformation. A first Q axis current value is based on a projection of the first phase current value (A phase current value) onto the Q axis and is derived using the Park transformation. A second Q axis current value is based on a projection of the desired second phase current value (desired B phase current value) onto the Q axis and is derived using the Park transformation. A third Q axis current value is based on a projection of the desired third phase current value (desired C phase current value) onto the Q axis and is derived using the Park transformation.

A sum of the first Q axis current value, the second Q axis current value, and the third Q axis current value are equal to zero. A sum of the second Q axis current value (associated with the desired B phase current value) and the third Q axis current value (associated with the C phase current value) is equal to and opposite in polarity to the first Q axis current value (associated with the A phase current value).

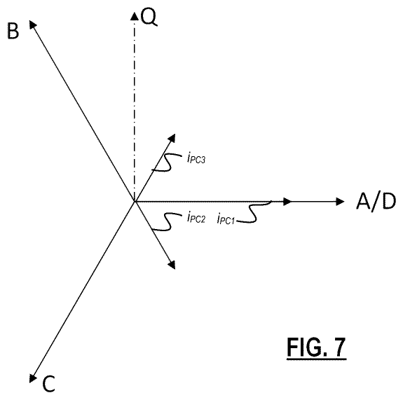

Referring to FIG. 7, a graphical illustration of an exemplary D-Q coordinate system where an angular position of a rotor is aligned with an A phase terminal of an electric motor 204 in accordance with at least one embodiment is shown. When the angular position of the rotor is aligned with the A phase terminal (first phase terminal) of the electric motor 204, the value of the offset angle θ₀ is zero. The first phase current value i_{PC1} (A phase current value) is aligned with the A axis. The first phase current value i_{PC1} is equal to the source AC value. The desired second phase current value i_{PC2} (B phase current value) is half the source AC value and has a phase with a polarity that is opposite a polarity of the single phase AC. The desired third phase current value (C phase current value) is half the source AC value and has a phase with a polarity that is opposite the polarity of the single phase AC.

Referring to FIG. 8, an exemplary circuit diagram of an inverter system 200 electrically coupled to an electric motor 204, a single phase AC power source 206, and leg circuitry 209 via a DC bus in accordance with at least one embodiment is shown. In at least one embodiment, the leg circuitry 209 is separate from the inverter system 200. In at least one embodiment, the leg circuitry 209 is integral with and a component of the inverter system 200. The electric motor 204 includes first, second, and third windings W1, W2, W3. Each of the first, second and third winding W1, W2, W2 is associated with one of an A phase terminal, a B phase terminal, and a C phase terminal of the electric motor 204. The DC bus includes a positive voltage bus bar 802 and a neutral bus bar 804. When the vehicle battery 202 is being charged by the single phase AC power source 206, the inverter system 200 is configured to electrically coupled to the DC bus. The leg circuitry 209 is a half-bridge connected across the DC link of the inverter system 200. The mid-point of the half-bridge 806 is connected to a neutral point of the single phase AC power source 206.

An exemplary current flow used to charge a vehicle battery 202 at a moment in time is depicted using dashed arrows. The current flow varies in real time as the single phase AC current that leaves a phase terminal of the single phase AC power source 206 varies in real time. During the vehicle battery 202 charging process, the single phase AC current leaves the phase terminal of the single phase AC power source 206 to the first winding W1 of the electric motor 204. The first winding W1 of the electric motor 204 is associated with a first phase terminal selected by the torque management system 100. The current splits between the second winding W2 and third winding W3 of the electric motor 204 and flows toward the DC bus via a second and a third leg of the inverter system 200. The second and third windings W2, W3 are associated with second and third phase terminals. The current that flows into the DC bus charges the vehicle battery 202 since the vehicle battery 202 is directly or indirectly (via a DC-DC converter 208) electrically coupled to the DC bus. During the charging process, the first leg of the inverter system 200 is not operational (i.e. the top and bottom power switches are open) and no current flows through the first leg.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of managing torque during charging of a vehicle battery comprising:
receiving, by the controller, an angular position of a rotor of an electric motor of a vehicle from a rotor position sensor;
determining, by the controller, an offset angle based on the angular rotor position of the rotor with respect to a first phase terminal of the electric motor;
receiving, by a controller, a source alternating current (AC) value of a single phase AC received from a single phase AC power source from a source current sensor of a vehicle;
determining, by the controller, a desired first phase current value, a desired second phase current value, and a desired third phase current value based on the source AC value and the offset angle; and
iteratively issuing a plurality of commands, by the controller, to an inverter system of the vehicle to apply different first terminal voltage values of a first terminal voltage to the first phase terminal of the electric motor, different second terminal voltage values of a second terminal voltage to a second phase terminal of the electric motor, and different third terminal voltage values of a third terminal voltage to a third phase terminal of the electric motor until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value, wherein:
the controller is electrically coupled to the source current sensor, the rotor position sensor, the first phase current sensor, the second phase current sensor, the third phase current sensor, and the inverter system,
the inverter system is electrically coupled to the first, second and third phase terminals of the electric motor, and
the inverter system is configured to provide electrical coupling between the AC single phase power source and the vehicle battery to enable charging of the vehicle battery.

2. The method of claim 1, further comprising:
determining, by the controller, the desired first phase current value using a first equation, the first equation being:
$${i}_{PC 1} = {i}_{A C}$$
wherein, i_{PC1} is the desired first phase current value, i_{AC} is a desired source AC value, and θ₀ is the offset angle;
determining, by the controller, the desired second phase current value using a second equation, the second equation being:
wherein, i_{PC2} is the desired
$${i}_{PC 2} = - {i}_{A C} [ \frac{cos ( {θ}_{0} + \frac{π}{3} )}{cos {θ}_{0}} ] ,$$
i_{AC} is a desired source AC value, and θ₀ is the offset angle; and
determining, by the controller, the third desired phase current value using a third equation, the third equation being:
$${i}_{PC 3} = - {i}_{PC 1} [ \frac{sin ( {θ}_{0} + \frac{π}{6} )}{cos {θ}_{0}} ] ,$$
wherein, i_{PC3} is the desired third phase current value, i_{AC} is the desired source AC value, and θ₀ is the offset angle.

3. The method of claim 1, wherein a desired source AC value is equal to the source AC value.

4. The method of claim 1, further comprising:
defining, by the controller, a direct-quadrature (D-Q) coordinate system comprising a direct (D) axis aligned with the offset angle and a quadrature (Q) axis at a 90° angle with respect to the D axis;
generating, by the controller, a D axis current value of a desired AC value using a Park transformation, the D axis current value being a projection of the desired AC value onto the D axis;
issuing, by the controller, a command to the inverter system to apply a D axis based voltage to the first phase terminal of the electric motor to generate the D axis current value as the first phase current value at the first phase terminal;
generating, by the controller, a first Q axis current value of the desired AC value using the Park transformation, the first Q axis current value being a projection of the desired AC value onto the Q axis; and
determining, by the controller, the desired second phase current value and the desired third phase current value based on a sum of the first Q axis current value, a second Q axis current value, and a third Q axis current value being equal to zero, wherein:
the second Q axis current value is based on a projection of the desired second phase current value onto the Q axis and is derived using the Park transformation, and
the third Q axis current value is based on a projection of the desired third phase current value onto the Q axis and is derived using the Park transformation.

5. The method of claim 4, further comprising:
determining, by the controller, whether the first phase terminal is an A phase terminal of the electric motor; and
calculating, by the controller, the D axis current value of a desired AC value using a fourth equation based on the determination, the fourth equation being:
$${i}_{d} = \frac{{i}_{A C}}{cos ( {θ}_{0} )}$$
wherein, i_{d} is the D axis current value, i_{AC} is the desired AC value, and θ₀ is the offset angle.

6. The method of claim 4, further comprising:
determining, by the controller, whether the first phase terminal is a B phase terminal of the electric motor; and
calculating, by the controller, the D axis current value of the source AC value using a fifth equation based on the determination, the fifth equation being:
$${i}_{d} = \frac{{i}_{A C}}{cos ( {θ}_{0} - 2 π / 3 )}$$
wherein, i_{d} is the D axis current value, i_{AC} is the desired AC value, and θ₀ is the offset angle.

7. The method of claim 4, further comprising:
determining, by the controller, whether the first phase terminal is a C phase terminal of the electric motor; and
calculating, by the controller, the D axis current value of the desired AC value using a sixth equation based on the determination, the sixth equation being:
$${i}_{d} = \frac{{i}_{A C}}{cos ( {θ}_{o} - 4 π / 3 )}$$
wherein, i_{d} is the D axis current value, i_{AC} is the desired AC current value, and θ₀ is the offset angle.

8. The method of claim 4, wherein:
the first Q axis current value is represented by a seventh equation the seventh equation being:
$${i}_{q 1} = {i}_{A C} sin {θ}_{0}$$
wherein, i_{q1} is the first Q axis current value, i_{AC} is the desired AC value, and θ₀ is the offset angle;
the second Q axis current value is represented by a eighth equation, the eighth equation being:
$${i}_{q 2} = {i}_{P C 2} sin ( {θ}_{0} - \frac{2 π}{3} )$$
wherein, i_{q2} is the second Q axis current value, i_{PC2} is the desired second phase current value, and θ₀ is the offset angle;
the third Q axis current value is represented by an ninth equation, the ninth equation being:
$${i}_{q 3} = {i}_{P C 3} sin ( {θ}_{0} + \frac{2 π}{3} )$$
wherein, i_{q3} is the third Q axis current value, i_{PC3} is the desired third phase current value, and θ₀ is the offset angle, and
$${i}_{q 1 +} {i}_{q 2 +} {i}_{q 3} = 0$$
wherein, i_{q1} is the first Q axis current value, i_{q2} the second Q axis current value, and i_{q3} the third Q axis current value.

9. The method of claim 1, wherein:
the electric motor comprises an A phase terminal, a B phase terminal, and a C phase terminal,
the A phase terminal is associated with an A positive polarity position and an A negative polarity position on a stator of the electric motor,
the B phase terminal is associated with a B positive polarity position and a B negative polarity position on the stator,
a C phase terminal is associated with a C positive polarity position and a C negative polarity position on the stator, and
the method further comprises:
upon a determination, by the controller, that one of the A positive polarity position and the A negative polarity position is closest to the angular position of the rotor, selecting the A phase terminal as the first phase terminal;
upon a determination, by the controller, that one of the B positive polarity position and the B negative polarity position is closest to the angular position of the rotor, selecting the B phase terminal as the first phase terminal; and
upon a determination, by the controller, that one of the C positive polarity position and the C negative polarity position is closest to the angular position of the rotor, selecting the C phase terminal as the first phase terminal.

10. The method of claim 1, wherein the method further comprises issuing a routing command, by the controller, to the inverter system to supply a charging voltage from the inverter system to the vehicle battery via a direct current to a direct current (DC-DC) converter, the charging voltage being associated with the single phase AC received from the single phase AC power source.

11. The method of claim 1, wherein:
the electric motor comprises an A phase terminal, a B phase terminal, and a C phase terminal, and
two of the A phase terminal, the B phase terminal, and the C phase terminal are available for selection, by the controller, as the first phase terminal.

12. The method of claim 1, further comprising:
determining, by the controller, whether the offset angle is zero; and
upon a determination that the offset angle is zero:
determining, by the controller, the desired second phase current value to be half of the source AC value and have a phase with a polarity that is opposite a polarity of the single phase AC; and
determining, by the controller, the desired third phase current value to be half of the source AC value and have a phase with a polarity that is opposite the polarity of the single phase AC.

13. A system for managing torque during charging of a vehicle battery comprising:
at least one processor; and
at least one memory communicatively coupled to the at least one processor, the at least one memory comprising instructions that upon execution by the at least one processor, causes the at least one processor to:
receive an angular position of a rotor of an electric motor of a vehicle from a rotor position sensor;
determine an offset angle based on the angular rotor position of the rotor with respect to a first phase terminal of the electric motor;
receive a source alternating current (AC) value of a single phase AC received from a single phase AC power source from a source current sensor of a vehicle;
determine a desired first phase current value, a desired second phase current value, and a desired third phase current value based on the source AC value and the offset angle; and
iteratively issue a plurality of commands to an inverter system of the vehicle to apply different first terminal voltage values of a first terminal voltage to the first phase terminal of the electric motor, different second terminal voltage values of a second terminal voltage to a second phase terminal of the electric motor, and different third terminal voltage values of a third terminal voltage to a third phase terminal of the electric motor until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value, wherein:
the at least one processor is electrically coupled to the source current sensor, the rotor position sensor, the first phase current sensor, the second phase current sensor, the third phase current sensor, and the inverter system,
the inverter system is electrically coupled to the first, second and third phase terminals of the electric motor, and
the inverter system is configured to provide electrical coupling between the AC single phase power source and the vehicle battery to enable charging of the vehicle battery.

14. The system of claim 13, wherein the at least one memory further comprises instructions that upon execution by the at least one processor, causes the at least one processor to determine the desired first phase current value using a first equation, the first equation being:
$${i}_{P C 1} = {i}_{A C}$$
wherein, i_{PC1} is the desired first phase current value, i_{AC} is a desired source AC value, and θ₀ is the offset angle;
determine the desired second phase current value using a second equation, the second equation being:
$${i}_{PC 2} = - {i}_{AC} [ \frac{cos ( {θ}_{0} + \frac{π}{3} )}{cos {θ}_{0}} ]$$
wherein, i_{PC2} is the desired second phase current value, i_{AC} is a desired source AC value, and θ₀ is the offset angle; and
determine the third desired phase current value using a third equation, the third equation being:
$${i}_{PC 3} = - {i}_{AC} [ \frac{sin ( {θ}_{0} + \frac{π}{6} )}{cos {θ}_{0}} ] ,$$
wherein, i_{PC3} is the desired third phase current value, i_{AC} is the desired source AC value, and θ₀ is the offset angle.

15. The system of claim 13, wherein the at least one memory further comprises instructions that upon execution by the at least one processor, causes the at least one processor to:
define a direct-quadrature (D-Q) coordinate system comprising a direct (D) axis aligned with the offset angle and a quadrature (Q) axis at a 90° angle with respect to the D axis;
generate a D axis current value of a desired AC value using a Park transformation, the D axis current value being a projection of the desired AC value onto the D axis;
issue a command to the inverter system to apply a D axis based voltage to the first phase terminal of the electric motor to generate the D axis current value as the first phase current value at the first phase terminal;
generate a first Q axis current value of the desired AC value using the Park transformation, the first Q axis current value being a projection of the desired AC value onto the Q axis; and
determine the desired second phase current value and the desired third phase current value based on a sum of the first Q axis current value, a second Q axis current value, and a third Q axis current value being equal to zero, wherein:
the second Q axis current value is based on a projection of the desired second phase current value onto the Q axis and is derived using the Park transformation, and
the third Q axis current value is based on a projection of the desired third phase current value onto the Q axis and is derived using the Park transformation.

16. The system of claim 15, wherein the at least one memory further comprises instructions that upon execution by the at least one processor, causes the at least one processor to:
determine whether the first phase terminal is an A phase terminal of the electric motor; and
calculate the D axis current value of a desired AC value using a fourth equation based on the determination, the fourth equation being:
$${i}_{d} = \frac{{i}_{A C}}{cos ( {θ}_{0} )}$$
wherein, i_{d} is the D axis current value, i_{AC} is the desired AC value, and θ₀ is the offset angle.

17. The system of claim 15, wherein the at least one memory further comprises instructions that upon execution by the at least one processor, causes the at least one processor to:
determine whether the first phase terminal is a B phase terminal of the electric motor; and
calculate the D axis current value of the source AC value using a fifth equation based on the determination, the fifth equation being:
$${i}_{d} = \frac{{i}_{A C}}{cos ( {θ}_{0} - 2 π / 3 )}$$
wherein, i_{d} is the D axis current value, i_{AC} is the desired AC value, and θ₀ is the offset angle.

18. The system of claim 15, wherein the at least one memory further comprises instructions that upon execution by the at least one processor, causes the at least one processor to:
determine whether the first phase terminal is a C phase terminal of the electric motor; and
calculate the D axis current value of the desired AC value using a sixth equation based on the determination, the sixth equation being:
$${i}_{d} \frac{{i}_{A C}}{cos ( {θ}_{0} - 4 π / 3 )}$$
wherein, i_{d} is the D axis current value, i_{AC} is the desired AC current value, and θ₀ is the offset angle.

19. The system of claim 15, wherein:
the first Q axis current value is represented by a seventh equation the seventh equation being:
$${i}_{q 1} = {i}_{A C} sin {θ}_{0}$$
wherein, i_{q1} is the first Q axis current value, i_{AC} is the desired AC value, and θ₀ is the offset angle;
the second Q axis current value is represented by a eighth equation, the eighth equation being:
$${i}_{q 2} = {i}_{P C 2} sin ( {θ}_{0} - \frac{2 π}{3} )$$
wherein, i_{q2} is the second Q axis current value, i_{PC2} is the desired second phase current value, and θ₀ is the offset angle;
the third Q axis current value is represented by an ninth equation, the ninth equation being:
$${i}_{q 3} = {i}_{P C 3} sin ( {θ}_{0} + \frac{2 π}{3} )$$
wherein, i_{q3} is the third Q axis current value, i_{PC3} is the desired third phase current value, and θ₀ is the offset angle, and
$${i}_{q 1} + {i}_{q 2} + {i}_{q 3} = 0$$
wherein, i_{q1} is the first Q axis current value, i_{q2} the second Q axis current value, and i_{q3} the third Q axis current value.

20. A vehicle including a system for managing torque during charging of a vehicle battery comprising:
at least one processor; and
at least one memory communicatively coupled to the at least one processor, the at least one memory comprising instructions that upon execution by the at least one processor, causes the at least one processor to:
receive an angular position of a rotor of an electric motor of a vehicle from a rotor position sensor;
determine an offset angle based on the angular rotor position of the rotor with respect to a first phase terminal of the electric motor;
receive a source alternating current (AC) value of a single phase AC received from a single phase AC power source from a source current sensor of a vehicle;
determine a desired first phase current value, a desired second phase current value, and a desired third phase current value based on the source AC value and the offset angle; and
iteratively issue a plurality of commands to an inverter system of the vehicle to apply different first terminal voltage values of a first terminal voltage to the first phase terminal of the electric motor, different second terminal voltage values of a second terminal voltage to a second phase terminal of the electric motor, and different third terminal voltage values of a third terminal voltage to a third phase terminal of the electric motor until a first phase current value detected by a first phase current sensor is equal to the desired first phase current value, a second phase current value detected by a second phase current sensor is equal to the desired second phase current value, and a third phase current value detected by a third phase current sensor is equal to the desired third phase current value, wherein:
the at least one processor is electrically coupled to the source current sensor, the rotor position sensor, the first phase current sensor, the second phase current sensor, the third phase current sensor, and the inverter system,
the inverter system is electrically coupled to the first, second and third phase terminals of the electric motor, and
the inverter system is configured to provide electrical coupling between the AC single phase power source and the vehicle battery to enable charging of the vehicle battery.
